(19) United States
(12) Patent Application Publication
(10) Pub. No.: US 2007/0047754 A1
(43) Pub. Date: Mar. 1, 2007

(54) Speaker device

(76) Inventor: Kawori Kishi, Yamagata (JP)

Correspondence Address: YOUNG & THOMPSON, 745 SOUTH 23RD STREET, 2ND FLOOR, ARLINGTON, VA, 22202, US

(21) Appl. No.: 11/513,041

(22) Filed: Aug. 31, 2006

(30) Foreign Application Priority Data
Sep. 1, 2005 (JP) 2005-253020

(51) Int. Cl. H04R 1/00

(52) U.S. Cl. 381/409

(57) ABSTRACT

A speaker device includes a diaphragm and a voice coil including plus and minus lead wires. In this speaker device, as a measure of fixing (reinforcing) each of the plus and minus lead wires, a solventless adhesive is used. Each of the plus and minus lead wires is fixed (reinforced) onto a sound output surface of the diaphragm by the solventless adhesive.

### BACKGROUND OF THE INVENTION

1. Field of the Invention

The present invention relates to a reinforcement method of a lead wire of a voice coil in a speaker device.

2. Description of Related Art

Generally, a speaker device mainly includes various kinds of components including a magnetic circuit having a yoke, a magnet and a plate, and a vibration system having a voice coil, a voice coil bobbin, a diaphragm, a cap and a frame. An adhesive, such as a two-pack type curable acrylic adhesive and a rubber-based solvent type adhesive, is used for joining various kinds of components (hereinafter referred to as “components for speaker device”) of the speaker device.

For example, when the vibration system is focused, each of plus and minus lead wires of the voice coil is normally drawn up to a surface of a sound output side of the diaphragm to be further fixed (reinforced) thereto by a rubber-based one-pack type adhesive (rubber-based solvent type adhesive) as a reinforcement adhesive. In addition, a flame retarder is added in the rubber-based one-pack type adhesive in order to prevent ignition caused due to heating of the lead wire.

As a manufacturing method of the speaker device having the configuration of this kind, there is known such a method that a speaker device is manufactured by enhancing wettability of a joint part between parts including hard-to-bond materials forming a speaker by a surface treatment, applying a moisture curable adhesive to the joint part of each material to which a water paint is applied, and attaching each parts (see Japanese Patent Application Laid-open under No. 2005-39405, for example). According to this manufacturing method of the speaker device, the moisture curable adhesive does not include an organic solvent unlike a rubber-based solvent type adhesive. Thereby, productivity and environment protecting measure are improved.

In addition, as the speaker device having the configuration of this kind, there is known a speaker device formed by integrating vibration system parts by using a moisture curable urethane-based hot melt adhesive having stickiness at the time of solidification (see Japanese Patent Application Laid-open under No. 6-125595, for example). Thereby, the small applying amount of solventless adhesive enables fixing in a short time, and a high performance speaker device with excellent mass production and tolerance can be obtained.

There is known a manufacturing method of an ultrasonic oscillator device formed by attaching a piezo-electric element to a ceiling surface of a housing via a solventless-type film adhesive in order to improve adhesion between the ceiling surface of the housing and the piezo-electric element (see Japanese Patent Application Laid-open under No. 6-320110, for example).

In a case of the speaker device having the above-mentioned configuration, work of applying an adhesive (rubber-based one-pack type adhesive) for reinforcement (fixing) of the lead wire of the voice coil to the diaphragm is executed in a final step of the manufacturing process of the speaker device.

Since the rubber-based one-pack type adhesive includes an organic solvent, it takes a long time until constant amount of organic solvent volatilizes and initial adhesion strength is ensured. Thus, in the manufacturing method of the speaker device, several-hour (substantially two hours in an actual line) drying time is necessary before advancing to a next process (test process of operation of the speaker device) of the applying work process. Thereby, it is problematic that the manufacturing time of the speaker device increases and manufacturing efficiency of the speaker device decreases. Additionally, since the adhesive includes the organic solvent, when drying thereof is insufficient, it is problematic that ignition is accelerated due to heating of each lead wire of the voice coil and the tolerance (heat resistance) to the ignition decreases. Further, since the adhesive includes the organic solvent, it is also problematic that the environment pollution is caused due to the volatilization of the organic solvent (environment load material).

### SUMMARY OF THE INVENTION

The present invention has been achieved in order to solve the above problems. It is an object of this invention to provide a speaker device capable of reducing an environment load material and shortening a manufacturing time.

According to one aspect of the present invention, there is provided a speaker device including a lead wire connected to a voice coil, wherein a solventless adhesive is used to fix the lead wire.

The above speaker device includes the lead wire electrically connected to the voice coil. In this speaker device, since the solventless adhesive is used as the measure of fixing (reinforcing) of the lead wire, it can be prevented that the organic solvent being the environment load material occurs. Thereby, the environment pollution can be reduced, which can contribute the environment protection. In addition, since the curing (drying) speed of the solventless adhesive is generally faster than that of the rubber-based solvent type adhesive, the manufacturing time of the speaker device can be shortened. Therefore, the manufacturing efficiency of the speaker device can be improved. Further, since the solventless adhesive does not include the organic solvent, even if drying is insufficient, it hardly ignites in correspondence with heating of the lead wire of the voice coil, and the tolerance (heat resistance) to the ignition can be improved.

In a preferred example, the solventless adhesive may be a moisture curable denatured silicone adhesive to which a flame retarder is added. In addition, the moisture curable denatured silicone adhesive may include an acrylic denatured silicone resin, and an inorganic filler (metal hydrate) serving as the flame retarder added to the acrylic denatured silicone resin.

In a manner, the speaker device may further include a diaphragm, wherein the lead wire is fixed (reinforced) onto a surface on a sound output side of the diaphragm by the solventless adhesive.

The nature, utility, and further features of this invention will be more clearly apparent from the following detailed description with respect to preferred embodiment of the invention when read in conjunction with the accompanying drawings briefly described below.

### BRIEF DESCRIPTION OF THE DRAWINGS

FIG. 1 shows a cross-sectional view of a speaker device according to an embodiment of the present invention; and

FIG. 2 is a plane view showing a reinforcement configuration of a lead wire of a voice coil according to this embodiment.

### DETAILED DESCRIPTION OF THE PREFERRED EMBODIMENTS

The preferred embodiment of the present invention will now be described below with reference to the attached drawings.

[Configuration of Speaker Device]

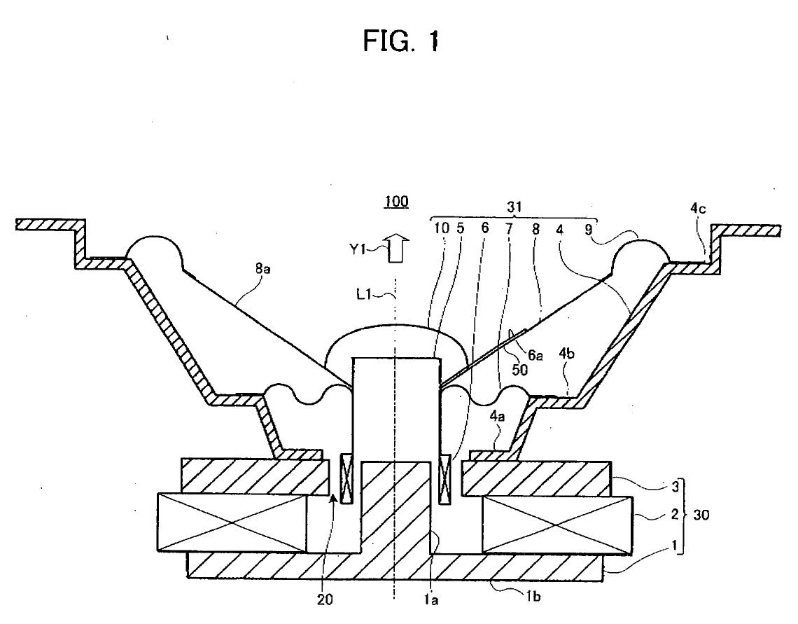

FIG. 1 shows a cross-sectional view of a speaker device 100 including the magnetic circuit of the present invention, taken along a plane surface including a central axis L1 thereof.

As shown in FIG. 1, the speaker device 100 mainly includes a magnetic circuit 30 including a yoke 1, a magnet 2 and a plate 3, and a vibration system 31 including a frame 4, a voice coil bobbin 5, a voice coil 6, a damper 7, a diaphragm 8, an edge 9 and a cap 10. In the present invention, a configuration and a driving system of the speaker device are not particularly limited.

First, a description will be given of the configuration of the magnetic circuit 30. The magnetic circuit 30 is configured as an external-magnet type magnetic circuit.

The yoke 1 is made of a metal material such as iron, and a coat such as galvanization is formed on a surface thereof. The yoke 1 has a pole part 1a formed into a substantially cylindrical shape and a flange part 1b outwardly extending from a lower end portion of an outer peripheral wall of the pole part 1a. The magnet 2 formed into a substantially annular shape is made of a ferrite magnet and a neodymium magnet, for example. The magnet 2 is mounted on an appropriate position on the flange part 1b of the yoke 1. The plate 3 is made of the same material as the yoke 1, for example, and it is mounted on the magnet 2. In the magnetic circuit 30 having the above-mentioned configuration, a magnetic gap 20 is formed between an inner peripheral wall of the plate 3 and the outer peripheral wall of the pole part 1a being the component of the yoke 1.

Next, a description will be given of the configuration of the vibration system 31.

The frame 4 having a substantial cup shape has a function to support plural component members for the speaker device. The frame 4 is made of a resin material such as ABS-PBT (Acrylonitrile Butadiene Styrene-Polybutylene Terephthalate) and PP (Polypropylene) or a metal material such as iron and aluminum, for example. When the frame 4 is made of the metal material such as the iron, it is preferable that the coat such as the galvanization or a painting coat is formed on a surface thereof. The frame 4 having a stepped cross-sectional shape includes a first step part 4a, a second step part 4b provided on an upper side of the first step part 4a and on an outer side thereof, and a third step part 4c provided on an upper side of the second step part 4b and on an outer side thereof. The first step part 4a of the frame 4 is mounted on the plate 3.

The voice coil bobbin 5 formed into a substantially cylindrical shape is made of a material such as aluminum, titanium, a polyimide resin (PI), paper and resin impregnated cloth, for example. A lower end portion of the voice coil bobbin 5 is arranged at a position covering the vicinity of an upper end portion of the pole part 1a of the yoke 1. Therefore, the vicinity of the lower end portion of the inner peripheral wall of the voice coil bobbin 5 is opposite to the vicinity of the upper end portion of the outer peripheral wall. Of the pole part 1a, and the vicinity of the lower end portion of the outer peripheral wall of the voice coil bobbin 5 is opposite to the inner peripheral wall of the plate 3 and a part of an inner peripheral wall of the magnet 2, respectively.

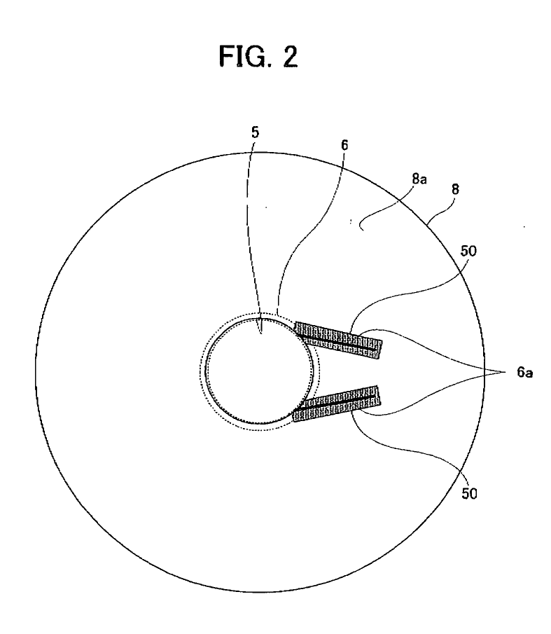

The voice coil 6 is made of a copper wire, for example, and a coat made of a resin material is formed on a surface thereof. The voice coil 6 has one wiring, which includes a lead wire 6a including a plus lead wire and a minus lead wire. The plus lead wire 6a is an input wiring for an L (or R)-channel signal, and the minus lead wire 6a is an input wiring for a ground (GND: ground) signal. The voice coil 6 is wound around the vicinity of the lower end portion of the outer peripheral wall of the voice coil bobbin 5. Each of the plus and minus lead wires 6a of the voice coil 6 is drawn up to a predetermined position on a surface 8a (hereinafter referred to as “sound output surface 8a”) on the sound output side of the diaphragm 8 along the outer peripheral wall of the voice coil bobbin 5 to be fixed to the sound output surface 8a of the diaphragm 8 via a solventless adhesive 50 (see FIG. 2) for reinforcement, which will be explained later. In addition, each of the plus and minus lead wires 6a is electrically connected to each of plus and minus tinsel cords (not shown) at a predetermined position on the sound output surface 8a of the diaphragm 8. Further, each of the plus and minus tinsel cords is connected to a terminal (not shown) provided at an appropriate position of the frame 4. The terminal is also connected to an output wiring (not shown) on an amplifier side, Thereby, l-channel signal and power is inputted to the voice coil 6 from the amplifier via the terminal, the plus and minus tinsel cords, the plus and minus lead wires 6a.

The damper 7 formed into a substantially annular shape has a wave-shaped elastic part which elastically supports the voice coil bobbin 5. An inner peripheral edge portion of the damper 7 is mounted in the vicinity of the upper end portion of the outer peripheral wall of the voice coil bobbin 5 and an outer peripheral edge portion of the damper 7 is mounted on the second step part 4b of the frame 4.

The diaphragm 8 has a function to radiate an acoustic wave corresponding to an input signal, and it is made of a resin material such as PP (Polypropylene) or a material such as paper, Kevler, or Glass Cloth, for example. An inner peripheral edge portion of the diaphragm 8, i.e., a neck part, is mounted on the upper end portion of the outer peripheral wall of the voice coil bobbin 5. In addition, the inner peripheral portion of the diaphragm 8 is joined to the inner peripheral portion of the damper 7 via an adhesive component (not shown).

The edge 9 has a substantially semicircular cross-sectional shape, and it is made of a material such as gum, urethane or a fabric. An inner peripheral edge portion of the edge 9 is mounted on the outer peripheral edge portion of the diaphragm 8, and an outer peripheral edge portion of the edge 9 is mounted on the third step part 4c of the frame 4. In this embodiment, the diaphragm 8 and the edge 9 are separately formed. However, the present invention is not limited to this, and the diaphragm 8 and the edge 9 may be integrally formed.

The cap 10 formed into a substantially hemi-sphere shape is made of a resin material such as PP (Polypropylene), PET (Polyethlene Terephthalate) or a material such as paper. A circumferential end portion of the cap 10 is mounted on the sound output surface 8a in the vicinity of the inner peripheral portion of the diaphragm 8. Therefore, the cap 10 has a function to prevent water and foreign from entering the magnetic circuit 30.

In the speaker device 100 having the above-mentioned configuration, the signal and power outputted from the amplifier are supplied to the voice coil 6 via the terminal, each of the plus and minus tinsel cords, and each of the plus and minus lead wires 6a of the voice coil 6. Thereby, driving force occurs to the voice coil 6 in the magnetic gap 20 to vibrate the diaphragm 8 in the direction of the central axis L1 of the speaker device 100. In this manner, the speaker device 100 irradiates the acoustic wave in the direction of an arrow Y1.

(Reinforcement Configuration of Lead Wire of Voice Coil)

Next, a description will be given of a reinforcement configuration of each of the plus and minus lead wires 6a of the voice coil according to the embodiment of the present invention, with reference to FIG. 2.

FIG, 2 shows a plane view including the diaphragm 8 when observed from a direction opposite to the direction of the arrow Y1 shown in FIG. 1. In FIG. 2, for convenience of explanation, only the minimum components including the diaphragm 8 are shown, and other components are omitted.

As shown in FIG. 1 and FIG. 2, the voice coil 6 is wound around the vicinity of the lower end portion of the outer peripheral wall of the voice coil bobbin 5. The inner peripheral edge portion of the diaphragm 8 is mounted on the vicinity of the upper end portion of the outer peripheral wall of the voice coil bobbin 5. Each of the plus and minus lead wires 6a of the voice coil 6 is drawn up to a predetermined position on the sound output surface 8a of the diaphragm 8 along the outer peripheral wall of the voice coil bobbin 5.

Particularly, in this embodiment, the solventless adhesive 50 is used as the measure of fixing (reinforcing) each of the plus and minus lead wires 6a of the voice coil 6. It is preferable that the solventless adhesive 50 is the moisture curable denatured silicone adhesive to which the flame retarder is added. The moisture curable denatured silicone adhesive is preferably produced by adding the inorganic filler (metal hydrate) serving as the flame retarder to the acrylic denatured silicone resin (e.g., “SUPER X No. 8008” produced by CEMEDINE CO., LTD.) serving as a base resin. In this embodiment, as the adhesive, “SX720B” produced by CEMEDINE CO., LTD. or a product having a much lower viscosity than that of “SX720B” may be used, for example.

Returning to FIG. 2, each of the plus and minus lead wires 6a of the voice coil 6 is fixed (reinforced) onto the sound output surface 8a of the diaphragm 8 by the above-mentioned solventless adhesive 50.

Next, a description will be given of characteristic operation and effect of the speaker device 100 of this embodiment in comparison with a comparative example.

Generally, when the rubber-based solvent type adhesive is used as the measure of fixing (reinforcing) each of the plus and minus lead wires 6a of the voice coil 6 (comparative example), there are problems as follows: a long time is necessary until constant amount of organic solvent volatilizes and an initial adhesion strength is ensured; the environment pollution is caused due to the volatilization of the organic solvent. Additionally, in the comparative example, when drying of the rubber-based solvent type adhesive is insufficient, it becomes possible that the ignition due to heating of each of the plus and minus lead wires 6a of the voice coil 6 is accelerated and the tolerance (e.g., heat resistance) to the ignition is problematically reduced.

On the contrary, in this embodiment, since the solventless adhesive 50 is used as the measure of fixing (reinforcing) of each of the plus and minus lead wires 6a of the voice coil 6, it can be prevented that the organic solvent being the environment load material is generated. Thereby, it becomes possible to reduce the environment pollution and contribute environment protection. In addition, since a curing (drying) speed of the solventless adhesive is generally faster than that of the rubber-based solvent type adhesive, a manufacturing time of the speaker device 100 can be shortened. Thus, manufacturing efficiency of the speaker device 100 can be improved. Moreover, since the solventless adhesive does not include any organic solvent, even if drying thereof is insufficient, the solventless adhesive hardly ignites in correspondence with heating of each of the plus and minus lead wires 6a of the voice coil 6. Hence, the tolerance (heat resistance) to the ignition can be improved.

The invention may be embodied on other specific forms without departing from the spirit or essential characteristics thereof. The present embodiments therefore to be considered in all respects as illustrative and not restrictive, the scope of the invention being indicated by the appended claims rather than by the foregoing description and all changes which come within the meaning an range of equivalency of the claims are therefore intended to embraced therein.

The entire disclosure of Japanese Patent Application No. 2005-253020 filed on Sep. 1, 2005 including the specification, claims, drawings and summary is incorporated herein by reference in its entirety.

What is claimed is:

1. A speaker device comprising a lead wire connected to a voice coil, wherein a solventless adhesive is used to fix the lead wire.

2. The speaker device according to claim 1, further comprising a diaphragm, wherein the lead wire is fixed onto a surface on a sound output side of the diaphragm by the solventless adhesive.

3. The speaker device according to claim 1, wherein the solventless adhesive is a moisture curable denatured silicone adhesive to which a flame retarder is added.

4. The speaker device according to claim 3, wherein the moisture curable denatured silicone adhesive includes an acrylic denatured silicone resin, and an inorganic filler serving as the flame retarder added to the acrylic denatured silicone resin.
